(19) United States
(12) Patent Application Publication
(10) Pub. No.: US 2026/0295841 A1
(43) Pub. Date: Oct. 1, 2026

(54) LOWER NOZZLE ATTACHMENT/DETACHMENT DEVICE

(71) Applicant: KROSAKIHARIMA CORPORATION, Fukuoka (JP)

(72) Inventors: Yusuke YAMAGUCHI, Fukuoka (JP); Yudai ONOUE, Fukuoka (JP); Asaki NIMURA, Fukuoka (JP); Mamoru YOSHIMURA, Fukuoka (JP)

(73) Assignee: KROSAKIHARIMA CORPORATION, Fukuoka (JP)

(21) Appl. No.: 19/488,946

(22) PCT Filed: May 28, 2024
(86) PCT No.: PCT/JP2024/019481

§ 371 Date: Dec. 1, 2025

(30) Foreign Application Priority Data
Jun. 5, 2023 (JP) 2023-092600

(51) Int. Cl. B25J 9/16; B22D 45/00; B25J 13/08

(52) U.S. Cl. CPC B25J 9/1687; B22D 45/00; B25J 13/085

(57) ABSTRACT

A lower nozzle attaching-detaching apparatus is designed to attach and detach a lower nozzle with respect to a lower plate and installed in a sliding nozzle device. The apparatus comprises: a holder capable of being attached and detached with respect to a holding metal frame that holds the lower nozzle; a robot arm having the holder at a tip thereof; a force sensor to detect a reaction force in a front/rear direction and a reaction force in a rotational direction, the two reaction forces being received by the holder from the frame along with movement of the robot arm; and a control unit to monitor and control movement of the robot arm. The control unit operates to perform the attaching and detaching of the lower nozzle by controlling movement of the robot arm while monitoring the forces detected by the force sensor, and movement of the robot arm.

### TECHNICAL FIELD

The present invention relates to a lower nozzle attaching-detaching apparatus for performing attaching and detaching, i.e., attaching-detaching, of a lower nozzle for use in a sliding nozzle device for controlling the flow rate of molten steel in continuous casting of molten steel.

### BACKGROUND ART

In a sliding nozzle device used in continuous casting of molten steel, a nozzle made of a refractory material and configured to rectify the flow of molten steel, i.e., a lower nozzle, is generally disposed on the side of a lower surface of a plate brick for controlling the flow rate of molten steel, i.e., a lower plate. This lower nozzle needs to be replaced earlier than the usable life of the plate, due to the adhesion of flying splashes and damage caused by oxygen cleaning. Therefore, generally, in order to allow the lower nozzle to be replaced independently, the lower nozzle is held with respect to a cylindrical metal sleeve fixed on the side of a lower surface of a plate-receiving metal frame that receives therein the lower plate, by a bayonet mechanism via an annular holding metal frame that holds the lower nozzle.

As an apparatus for attaching and detaching such a lower nozzle and a holding metal frame therefor, for example, Patent Document 1 discloses an attaching-detaching apparatus comprising a drive mechanism capable of controlling torque and rotational angle. Further, Patent Document 2 discloses a method of rotating a holding metal frame for a lower nozzle with a specified torque.

### PRIOR ART DOCUMENTS

### Patent Document

Parent Document 1: JP H06-254670 A

Patent Document 2: JP 2016-525452 A

### SUMMARY OF INVENTION

### Technical Problem

As a result of repeatedly conducting lower nozzle attaching-detaching tests, the present inventors have found that attaching and detaching of a lower nozzle cannot be reliably performed only by controlling torque and rotational angle as in the conventional technique. Specifically, comparing before and after use, a lower nozzle changes in shape due to significant wear and a holding metal frame and a metal sleeve for the lower nozzle are also largely deformed due to external force and/or thermal expansion caused by temperature change, so that frictional resistance during the attaching and detaching varies significantly. For this reason, it is impossible to reliably perform the attaching and detaching of the lower nozzle only by controlling torque and rotational angle.

Therefore, the technical problem to be solved by the present invention is to provide a lower nozzle attaching-detaching apparatus capable of reliably performing the attaching and detaching of a lower nozzle.

### Solution to Technical Problem

In order to solve the above technical problems, the present inventors further conducted lower nozzle attaching-detaching tests. As a result, the present inventors have found that it is effective to, during attaching and detaching of a lower nozzle, control the movement of the robot arm while monitoring two reaction forces acting on the robot arm in a front/rear direction (i.e., in a front or rear direction) and in a rotational direction, and two movement amounts in the front/rear direction and in the rotational direction of the robot arm (i.e., a movement amount in the front/rear direction of the robot arm and a movement amount in the rotational direction of the robot arm).

Specifically, according to one aspect of the present invention, the following lower nozzle attaching-detaching apparatus is provided.

A lower nozzle attaching-detaching apparatus for attaching and detaching a lower nozzle made of a refractory material with respect to a lower plate made of a refractory material and installed in a sliding nozzle device, the lower nozzle attaching-detaching apparatus comprising: a holder capable of being attached and detached with respect to a holding metal frame that holds the lower nozzle; a robot arm having the holder at a tip thereof; a force sensor to detect a reaction force in a front/rear direction and a reaction force in a rotational direction, the two reaction forces being received by the holder from the holding metal frame along with a movement of the robot arm; and a control unit to monitor and control the movement of the robot arm, wherein the control unit operates to perform attaching and detaching of the lower nozzle by controlling the movement of the robot arm while monitoring the two reaction forces detected by the force sensor, and two movement amounts in the front/rear direction and in the rotational direction of the robot arm.

### Advantageous Effects of Invention

According to the present invention, it becomes possible to reliably perform the attaching and detaching of a lower nozzle.

### BRIEF DESCRIPTION OF THE DRAWINGS

FIG. 1 is an overall configuration diagram of a lower nozzle attaching-detaching apparatus according to one embodiment of the present invention.

FIG. 2 is a sectional view of a relevant part, showing a usage state of the lower nozzle attaching-detaching apparatus in FIG. 1.

FIG. 3 is an exploded side view showing a holder of the lower nozzle attaching-detaching apparatus in FIG. 1, a lower nozzle to be attached or detached, etc.

FIG. 4 is an exploded perspective view showing the holder of the lower nozzle attaching-detaching apparatus of FIG. 1, the lower nozzle to be attached or detached.

FIG. 5 is a perspective view showing the holder of the lower nozzle attaching-detaching apparatus in FIG. 1, in a standalone state.

FIG. 6A is a perspective view of the relevant part, showing a state in which the holder has been engaged with a holding metal frame during a lower nozzle detaching operation by the lower nozzle attaching-detaching apparatus in FIG. 1.

FIG. 6B is a longitudinal sectional view of FIG. 6A.

FIG. 7A is a perspective view of the relevant part, showing a state in which the lower nozzle has been detached by moving the holder in a rear direction while rotating the holder in a counterclockwise direction from the state of FIG. 6A.

FIG. 7B is a longitudinal sectional view of FIG. 7A.

FIG. 8A is a perspective view of the relevant part, showing a state in which the holding metal frame holding the lower nozzle has been detached from a metal sleeve by moving the holder in the rear direction from the state of FIG. 7A.

FIG. 8B is a longitudinal sectional view of FIG. 8A.

FIG. 9A is a perspective view of the relevant part, showing a state in which the holder is moved in the rear direction from the state of FIG. 8A, and the lower nozzle is pulled out from the metal sleeve

FIG. 9B is a longitudinal sectional view of FIG. 9A.

FIG. 10A is a perspective view of the relevant part, showing a state in which the holding metal frame holding a lower nozzle has been attached to the holder during a lower nozzle attaching operation by the lower nozzle attaching-detaching apparatus in FIG. 1.

FIG. 10B is a longitudinal sectional view of FIG. 10A.

FIG. 11A is a perspective view of the relevant part, showing a state in which protrusions of the holding metal frame have been fit into respective grooves of the metal sleeve by moving the holder in a front direction from the state of FIG. 10A.

FIG. 11B is a longitudinal sectional view of FIG. 11A.

FIG. 12A is a perspective view of the relevant part, showing a state in which the lower nozzle has been attached to a lower plate by moving the holder in the front direction while rotating the holder in a clockwise direction from the state of FIG. 11A.

FIG. 12B is a longitudinal sectional view of FIG. 12A.

### DESCRIPTION OF EMBODIMENTS

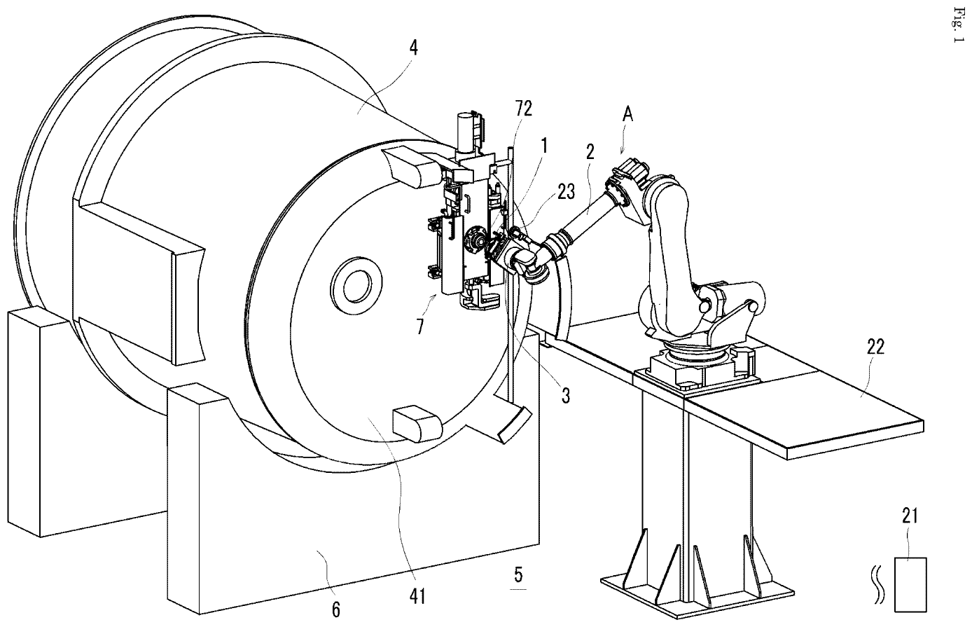

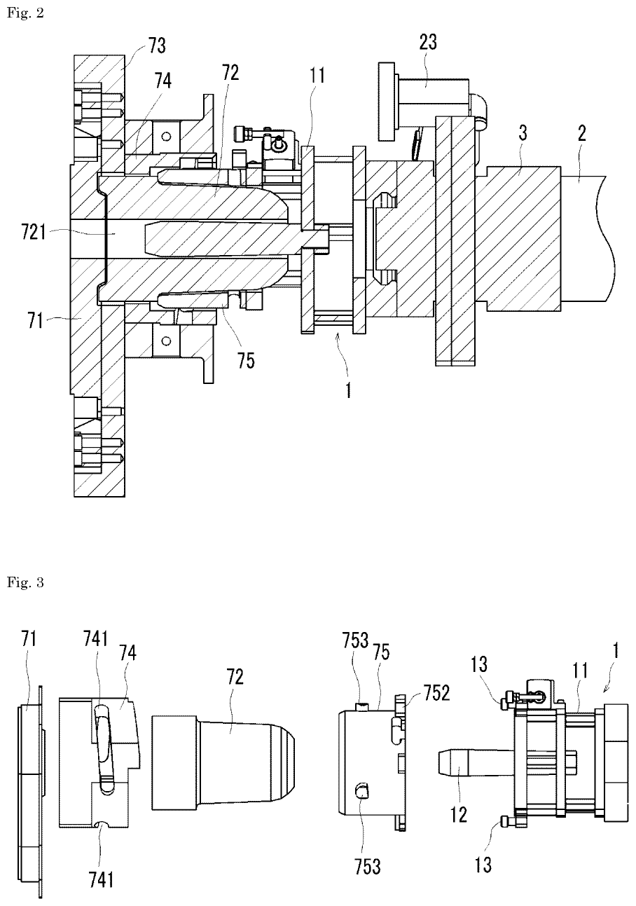

FIG. 1 shows an overall configuration of a lower nozzle attaching-detaching apparatus A according to one embodiment of the present invention. FIG. 2 shows a usage state of the lower nozzle attaching-detaching apparatus A in the form of the section of a relevant part.

In FIG. 1, a ladle 4 immediately after completion of casting is horizontally laid down on a ladle support 6 installed on a floor 5. A sliding nozzle device 7 is attached to the bottom 41 of the ladle with a sliding direction thereof oriented approximately in a vertical direction in the state of FIG. 1.

The lower nozzle attaching-detaching apparatus A is an apparatus for attaching and detaching a lower nozzle 72 made of a refractory material with respect to a lower plate 71 (see FIG. 2) made of a refractory material and installed in a sliding nozzle device 7. As appearing in FIG. 2, the lower nozzle 72 is held with respect to a cylindrical metal sleeve 74 fixed on the side of a lower surface of a plate-receiving metal frame 73 that receives therein the lower plate 71, by a bayonet mechanism via an annular holding metal frame 75 that holds the lower nozzle 72.

The lower nozzle attaching-detaching apparatus A comprises: a holder 1 capable of being attached and detached with respect to the annular holding metal frame 75 that holds the lower nozzle 72; a robot arm 2 having the holder 1 at a tip thereof; a force sensor 3 to detect a reaction force in a front/rear direction and a reaction force in a rotational direction, each received by the holder 1 from the holding metal frame 75 along with the movement of the robot arm 2; and a control unit 21 to monitor and control the movement of the robot arm 2.

As shown in FIG. 1, in this embodiment, the robot arm 2 is fixed to a robot arm mount 22 whose base end is placed on the floor 5. Then, the force sensor 3 is mounted to a distal end of the robot arm 2. At this time, the force sensor 3 and the distal end of the robot arm 2 are arranged in series such that their central axes coincide with each other. It should be noted, however, that the force sensor 3 may be provided on the side of the holder 1 independently of the robot arm 2. In this case, the force sensor 3 and the distal end of the robot arm 2 are also arranged in series such that their central axes coincide with each other. The force sensor to detect the reaction forces as just described is also referred to as a haptic sensor, and any force sensor commonly used for a robot arm, etc., may be employed, and in this embodiment, a six-axis force sensor is used as the force sensor 3. Further, in this embodiment, the robot arm 2 is a six-axis vertical articulated robot arm, wherein it is capable of freely moving the posture and position of the holder 1 attached to the tip thereof.

In this embodiment, a three-dimensional (3D) sensor 23 having a camera and a laser irradiator is mounted to a distal end portion of the robot arm 2. An image captured by the camera is input to an image processing device, and three-dimensional position coordinates of the sliding nozzle device 7 are corrected by an image processing method. By inputting this coordinate information to the control unit 21, the robot arm 2 can move the holder 1 to a predetermined position for attaching or detaching the lower nozzle 72. On the other hand, the above-mentioned two reaction forces (the reaction force in the front/rear direction and the reaction force in the rotational direction) detected by the force sensor 3 are always input to the control unit 21. As will be described in detail later, the control unit 21 operates to perform attaching and detaching of the lower nozzle 72 by controlling the movement of the robot arm 2 while monitoring the above-mentioned two reaction forces detected by the force sensor 3, and two movement amounts in the front/rear direction and in the rotational direction of the robot arm 2. The two movement amounts in the front/rear direction and in the rotational direction of the robot arm 2 are recognized from the robot arm 2 itself. That is, the robot arm 2 is provided with encoder-equipped motors for causing the robot arm 7 to move in the front/rear direction and in the rotational direction, and the control unit 21 recognizes the two movement amounts in the front/rear direction and in the rotational direction of the robot arm 2, based on values of encoders in the motors.

Next, the configuration of the holder 1 will be described. FIG. 3 and FIG. 4 show the holder 1 and the lower nozzle 72 and others to be attached and detached by the lower nozzle attaching-detaching apparatus A comprising the holder 1, in an exploded manner. In FIG. 5, the holder 1 alone is shown in a perspective view. It should be noted that in FIGS. 3 and 4, the plate-receiving metal frame is omitted.

As appearing in FIG. 2 and FIGS. 3 to 5, the holder 1 comprises: a base body 11; and a core rod 12, an engagement pin 13, and a clamp 14, each attached to the base body 11.

The base body 11 is an annular structure having a space 111 into which a lower end of the lower nozzle 72 can be inserted, and a base end of the base body 11 is attached to the tip of the robot arm 2.

The core rod 12 is provided along the central axis of the space 111, and is inserted into a nozzle bore 721 of the lower nozzle 72 during use, e.g., as shown in FIG. 2, to hold the lower nozzle 72.

The engagement pin 13 is provided in the number of two at respective mutually separated positions in such a manner as to protrude from a distal end of the base body 11 in the front direction, and the clamp 14 is provided in the vicinity of one of the two engagement pins 13. The functions, etc., of the engagement pins 13 and the clamp 14 will be described later.

The holding metal frame 75 to be attached and detached with respect to the holder 1 has a lower end provided with: two catching notches 751 each extending in a circumferential direction of the holding metal frame 75 and engageable with a respective one of the engagement pins 13 in the rotational direction; and two catching through-holes 752 each extending in an axial direction of the holding metal frame 75 and engageable with a respective one of the engagement pins 13 inserted thereinto in the front direction. As will be described in detail later, during the detaching of the lower nozzle 7, each of the catching notches 751 is engaged with a respective one of the engagement pins 13, and during the attaching of the lower nozzle 7, each of the catching through-holes 752 is engaged with a respective one of the engagement pins 13. That is, during the detaching of the lower nozzle 7, in order to avoid undesirable interference between the engagement pins 13 and the holding metal frame 75 due to variation in the positions of the engagement pins 13 in the rotational direction, each of the engagement pins 13 is engaged with a respective one of the catching notches 751. On the other hand, during the attaching of the lower nozzle 72, each of the engagement pins 13 is engaged with a respective one of the catching through-holes 752 because an operator can finely adjust the position of the holding metal frame 75. FIG. 2 shows a state during the attaching, i.e., a state in which the catching though-holes 752 are engaged with the engagement pins 13.

The holding metal frame 75 holding the lower nozzle 72 is attached and detached with respect to the metal sleeve 74 via the bayonet mechanism. Specifically, as the bayonet mechanism, the holding metal frame 75 has three protrusions 753 on an outer peripheral surface thereof, whereas the metal sleeve 74 has three spiral grooves 741 each for fittingly receiving a respective one of the protrusions 753.

Next, the operation of the lower nozzle attaching-detaching apparatus A will be described. First, a detaching operation during the detaching of the lower nozzle will be described.

First, the three-dimensional position coordinates of the sliding nozzle device 7 are corrected by: radiating a laser beam from a laser irradiator of the 3D sensor 23 toward a marker (illustration is omitted) which is an imaging reference point provided in the sliding nozzle device 7; capturing an image of the reference point by a camera; and subjecting the captured image to imager processing to calculate a deviation from the reference position of the sliding nozzle device 7. By inputting the corrected position coordinates of the sliding nozzle device 7 to the control unit 21, the robot arm 2 is operated to move the holder 1 attached to the robot arm 2 to a predetermined position in front of the lower nozzle 72 attached to the sliding nozzle device 7. FIG. 1 shows a state in the process of moving to the predetermined position.

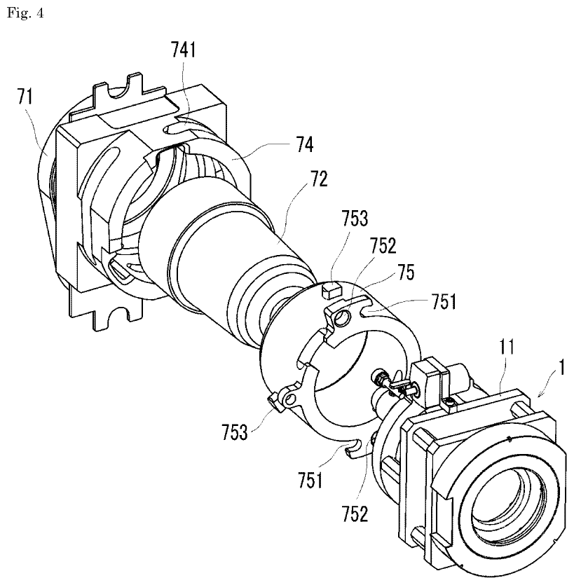

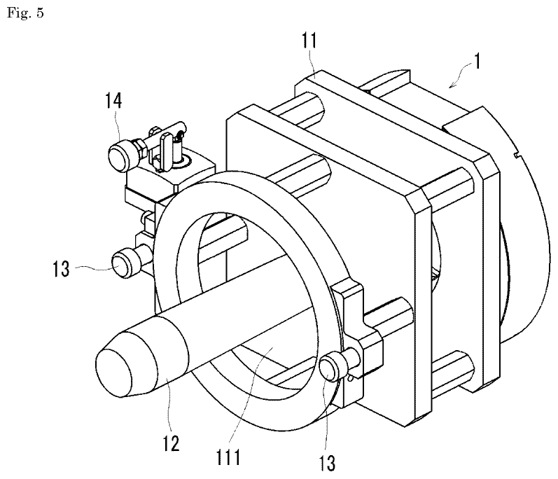

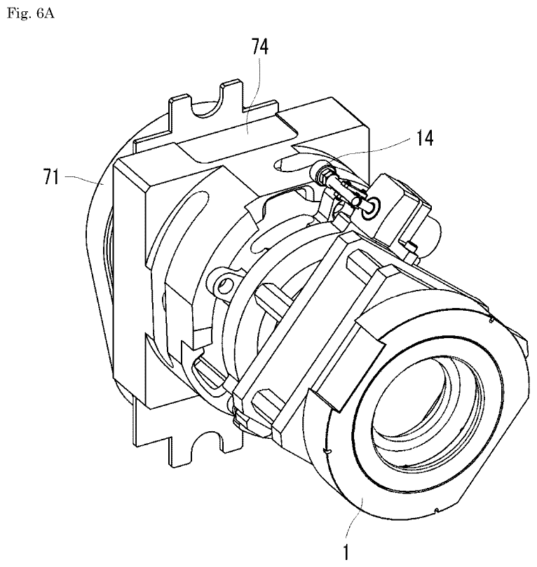

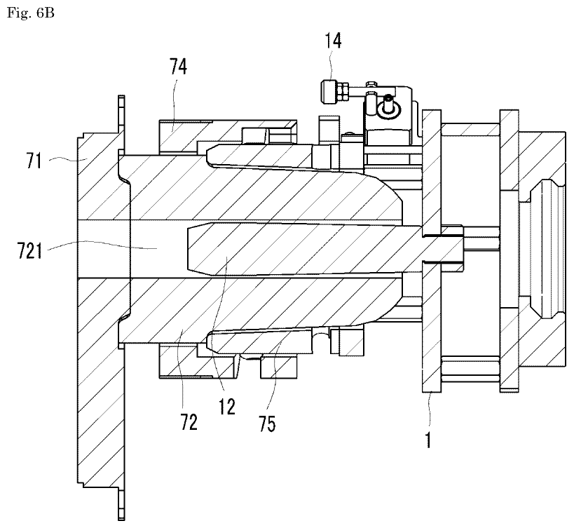

In this embodiment, the control unit 21 controls the movement of the robot arm 2 to move the holder 1 to the predetermined position, and after stopping the holder 1 at the predetermined position once, further move the holder 1 toward the lower nozzle 72 in the front direction. Thus, the two engagement pins 13 are engaged, respectively, with the two catching notches 751, and the core rod 12 is inserted into the nozzle bore 721. FIGS. 6A and 6B show this state in the form of a perspective view and a longitudinal sectional view, respectively. Note that in FIGS. 6A and 6B, the plate-receiving metal frame is omitted. The same applies to the following drawings.

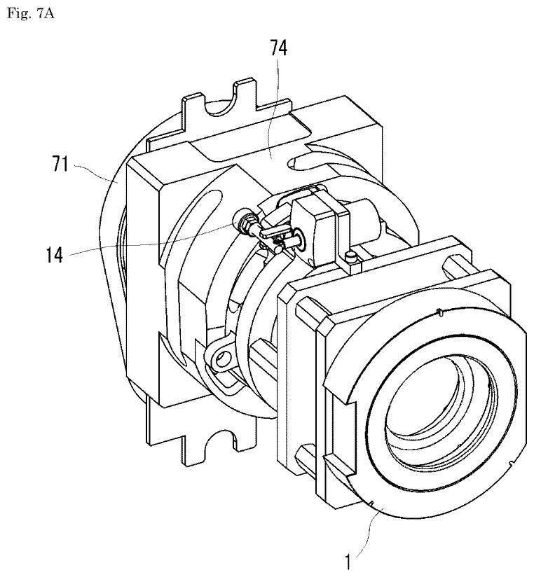

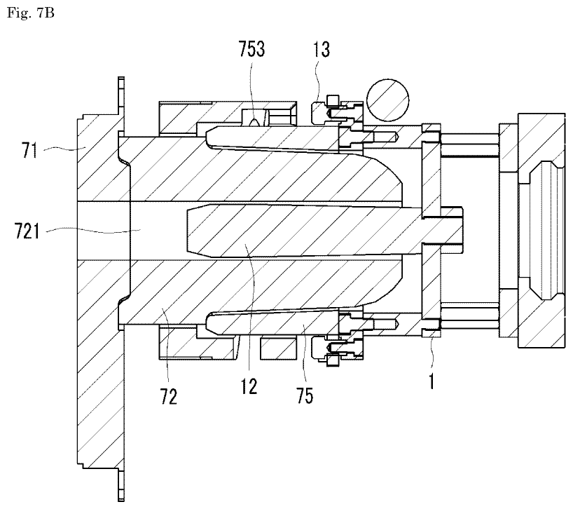

From the state of FIGS. 6A and 6B, the control unit 21 controls the movement of the robot arm 2 to rotate the holder 1 in a direction causing the bayonet mechanism to be loosened (in this embodiment, in the counterclockwise direction), while moving the holder 1 in a direction along which the lower nozzle 72 is to be detached, i.e., in the rear direction. In this process, the control unit 21 controls the movement of the robot arm 2 while monitoring the above-mentioned two reaction forces detected by the force sensor 3, and two movement amounts in the rear direction and in the rotational direction of the robot arm 2. Specifically, in this embodiment, when each of the two movement amounts in the rear direction and in the rotational direction of the robot arm 2 reaches a respective predetermined set value at a predetermined timing, without each of the two reaction forces detected by the force sensor 3 reaching a respective predetermined set value, it is determined that the detaching of the lower nozzle 72 has been completed normally. FIGS. 7A and 7B show this state in the form of a perspective view and a longitudinal sectional view. Specifically, in this state, the bayonet mechanism is normally released, and at this stage, it can be determined that the detaching of the lower nozzle 72 has been completed. In this embodiment, the two movement amounts in the rear direction and the rotational direction of the robot arm 2 from the state of FIG. 6A and FIG. 6B to the state of FIGS. 7A and 7B are about 3 mm and about 25 degrees, respectively.

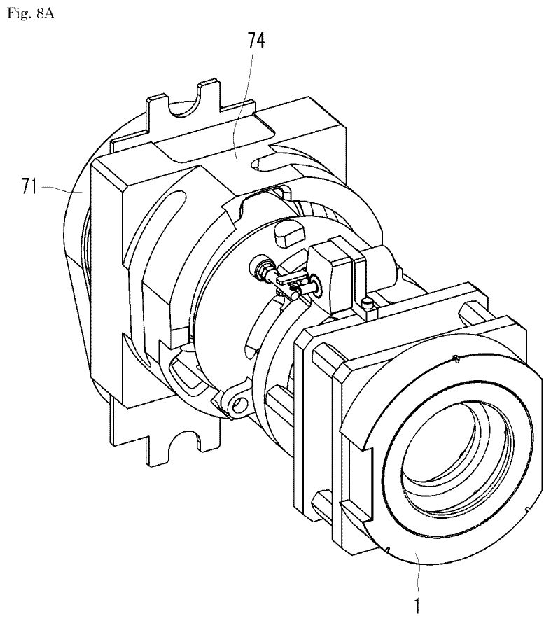

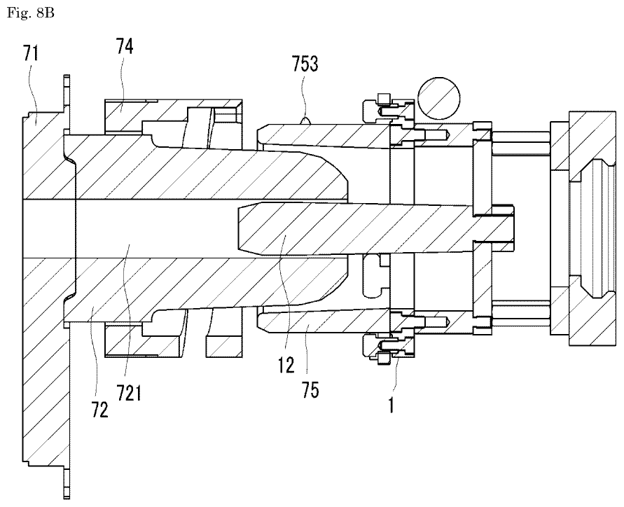

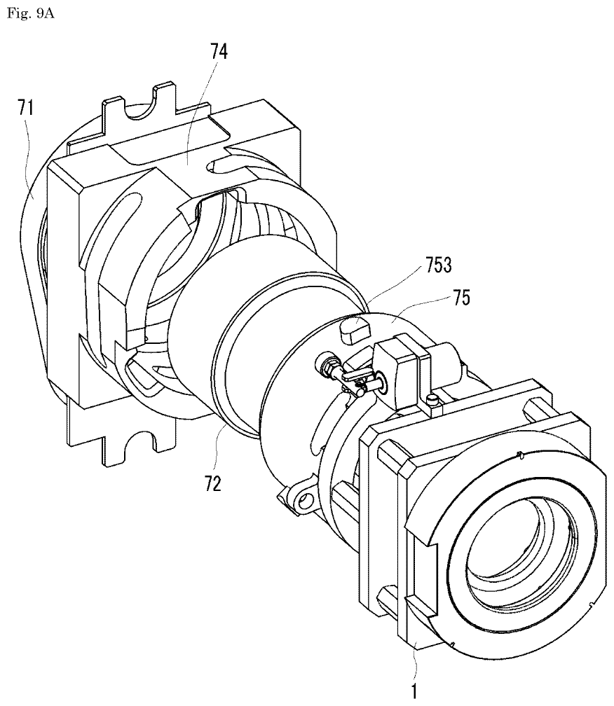

Then, the control unit 21 controls the movement of the robot arm 2 to further move the holder 1 in the rear direction, and detach the holding metal frame 75 holding the lower nozzle 72, from the metal sleeve 74, as shown in FIGS. 8A and 8B. Subsequently, as needed, the control unit 21 operates to move the robot arm 2 in an up-down direction to thereby separate a sealing joint between the lower nozzle 72 and the lower plate 71. Then, the control unit 21 controls the movement of the robot arm 2 to further move the holder 1 in the rear direction. Thus, as shown in FIGS. 9A and 9B, the lower nozzle 72 can be pulled out from the metal sleeve 74. Further, the control unit 21 controls the movement of the robot arm 2 to tilt the holder 1 downwardly. This makes it possible to drop and discard only the lower nozzle 72. Further, when the holder 1 is tilted downwardly, the above-mentioned clamp 14 can be activated to to reliably keep the engagement between the engagement pins 13 and the catching notches 751. This makes it possible to, when tilting the holder 1 downwardly, reliably drop only the lower nozzle 72 without dropping the holding metal frame 75.

On the other hand, when, during the detaching of the lower nozzle 72, at least one of the two reaction forces detected by the force sensor 3 reaches the respective predetermined set value at the predetermined timing, the control unit 21 determines as abnormal detaching, and operates to stop the movement of the robot arm 2. Specifically, the fact that at least one of the two reaction forces detected by the force sensor 3 reaches the respective predetermined set value means that the bayonet mechanism is less likely to be loosened due to an increase in the frictional resistance in the bayonet mechanism, and if the detaching operation is continued in such a state, there is a possibility that the holder 1, the robot arm 2 or the like is damaged. Therefore, in this embodiment, when at least one of the two reaction forces detected by the force sensor 3 reaches the respective predetermined set value, the control unit 21 determines as abnormal detaching, and operates to stop the movement of the robot arm 2. After stopping the movement of the robot arm 2, the control unit 21 may operate to move the robot arm 2 in the reverse direction once, and then restart the above-mentioned detaching operation.

Next, an attaching operation during the attaching of the lower nozzle will be described.

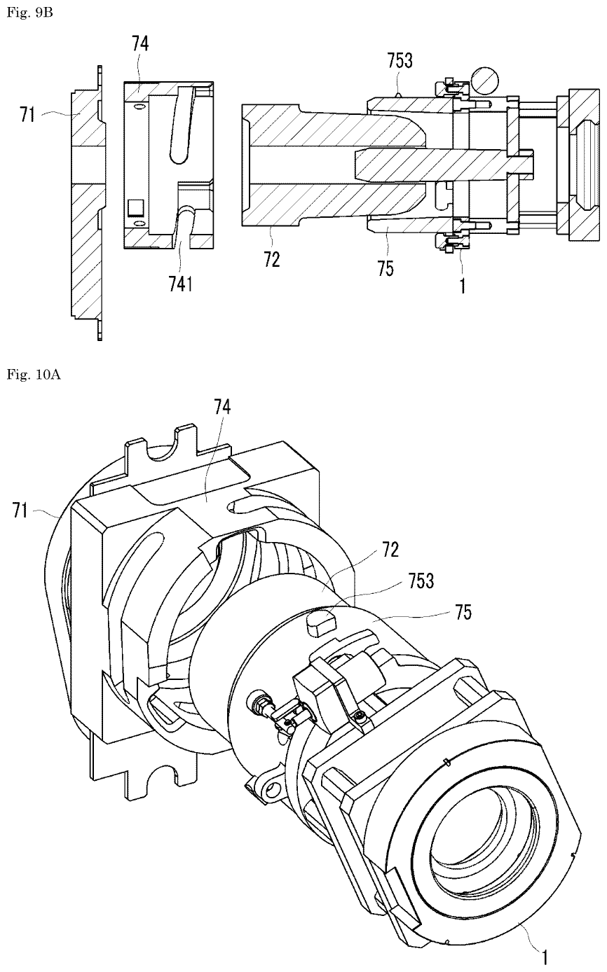

First, the holding metal frame 75 holding the lower nozzle 72 is attached to the holder 1 attached to the tip of the robot arm 2. Specifically, in this embodiment, the holding metal frame 75 holding the lower nozzle 72 is attached to the holder 1 by inserting each of the engagement pins 13 of the holder 1 into a respective one of the catching through-holes 752 of the holding metal frame 75. FIGS. 10A and 10B show this state in the form of a perspective view and a longitudinal sectional view. The above-mentioned operation of attaching the holding metal frame 75 holding the lower nozzle 72 to the holder 1 can be performed by the operator. During this operation, the operator can also apply or install a sealing joint material to an upper end face of the lower nozzle 72.

Subsequently, in the same manner as that during the detaching operation, the three-dimensional position coordinates of the sliding nozzle device 7 are corrected by: radiating a laser beam from a laser irradiator of the 3D sensor 23 toward a marker (illustration omitted) which is an imaging reference point provided in the sliding nozzle device 7; capturing an image of the reference point by a camera; and subjecting the captured image to imager processing to calculate a deviation from the reference position of the sliding nozzle device 7. By inputting the corrected position coordinates of the sliding nozzle device 7 to the control unit 21, the robot arm 2 is operated to move the holding metal frame 75 and the lower nozzle attached to the holder 1 to a predetermined position in front of the metal sleeve 74 fixed to the sliding nozzle device 7.

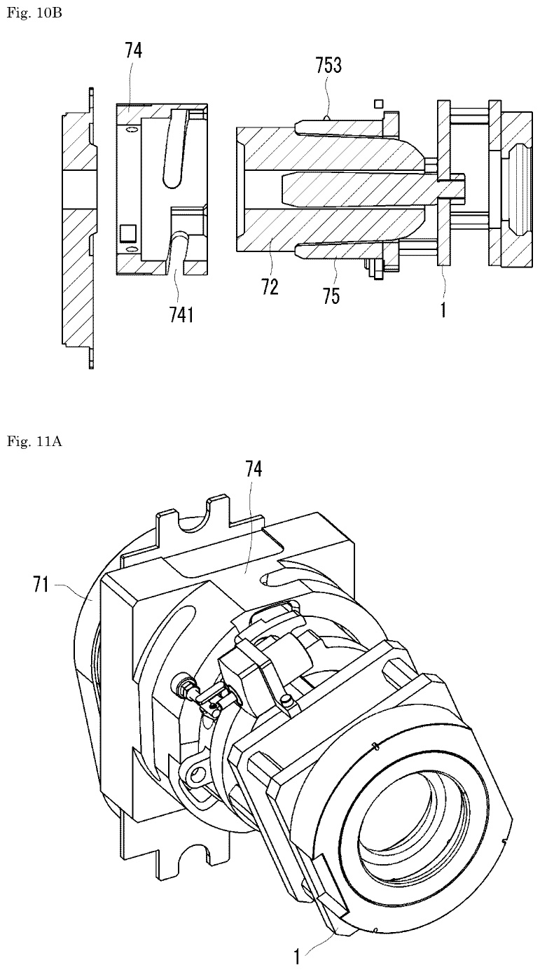

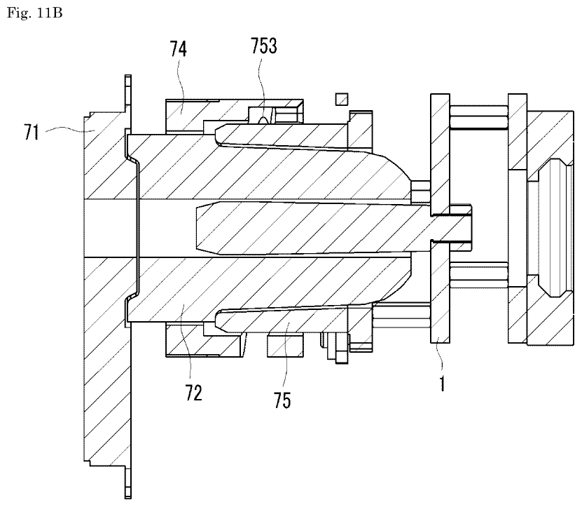

In this embodiment, the control unit 21 controls the movement of the robot arm 2 to move the holder 1 to the predetermined position, and after stopping the holder 1 at the predetermined position once, further move the holder 1 toward the metal sleeve 74 in the front direction. Thus, the upper end face of the lower nozzle 72 (the sealing joint material) comes into contact with the lower plate 71, and each of the protrusions 753 of the holding metal frame 75 fits into a respective one of the grooves 741 of the metal sleeve 74, whereby the holding metal frame 75 is set in a position capable of configuring the bayonet mechanism. FIGS. 11A and 11B show this state in the form of a perspective view and a longitudinal sectional view.

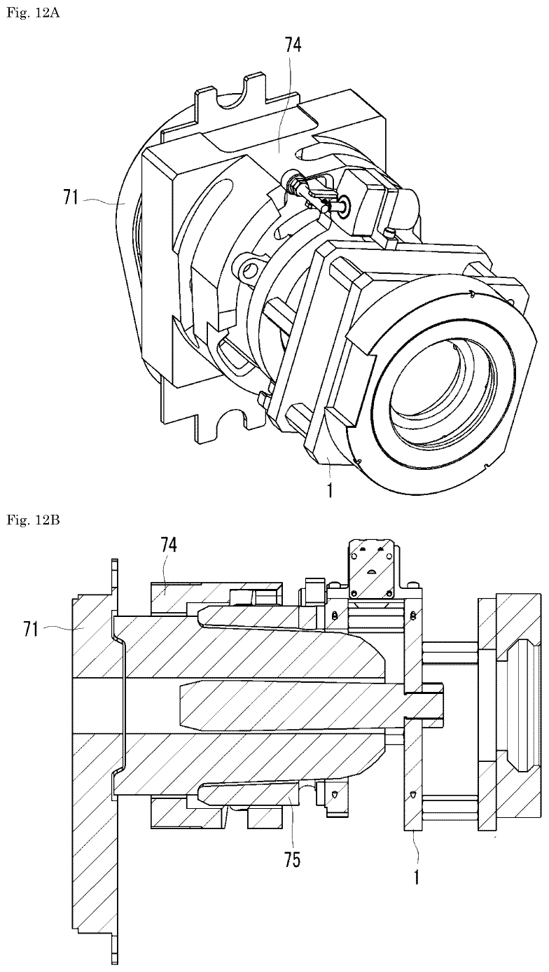

From this state, the control unit 21 controls the movement of the robot arm 2 to rotate the holder 1 in a direction causing the bayonet mechanism to be tightened (in this embodiment, in a clockwise direction), while moving the holder 1 in a direction along which the lower nozzle 72 is to be attached, i.e., in the front direction. In this process, the control unit 21 controls the movement of the robot arm 2, while monitoring the two reaction forces detected by the force sensor 3 and the two movement amounts in the front direction and in the rotational direction of the robot arm 2. Specifically, in this embodiment, when each of the two reaction forces detected by the force sensor 3 reaches a respective predetermined set value at a predetermined timing and each of the two movement amounts in the front direction and in the rotational direction of the robot arm 2 reaches a respective predetermined set value, it is determined that attaching of the lower nozzle 72 has been completed normally. FIGS. 12A and 12B show this state in the form of a perspective view and a longitudinal sectional view.

Then, the control unit 21 controls the movement of the robot arm 2 to move the holder 1 in the rear direction. Thus, the engagement pins 13 of the holder 1 are disengaged from the catching through-holes 752 of the holding metal frame 75, and only the holder 1 is moved in the rear direction.

On the other hand, when, during the attaching of the lower nozzle 72, at least one of the two movement amounts in the front direction and in the rotational direction of the robot arm does not reach the respective predetermined set value at a time when at least one of the two reaction forces detected by the force sensor 3 reaches the respective predetermined set value at the predetermined timing, the control unit 21 determines as abnormal attaching, and operates to stop the movement of the robot arm 2. Specifically, this situation means that the bayonet mechanism is less likely to be tightened due to an increase in the frictional resistance in the bayonet mechanism, and if the attaching operation is continued in such a state, there is a possibility that the holder 1, the robot arm 2 or the like is damaged. Therefore, in this embodiment, when at least one of the two movement amounts in the front direction and in the rotational direction of the robot arm does not reach the respective predetermined set value at the time when at least one of the two reaction forces detected by the force sensor 3 reaches the respective predetermined set value, the control unit 21 determines as abnormal attaching, and operates to stop the movement of the robot arm 2. After stopping the movement of the robot arm 2, the control unit 21 may operate to move the robot arm 2 in the reverse direction once, and then restart the above-mentioned attaching operation.

As described above, in this embodiment, the control unit 21 performs the attaching and detaching of the lower nozzle by controlling the movement of the robot arm 2 while monitoring the two reaction forces detected by the force sensor 3 and the two movement amounts in the front/rear direction and in the rotational direction of the robot arm 2. This makes it possible to reliably perform the attaching and detaching of the lower nozzle 72.

### LIST OF REFERENCE SIGNS

A: lower nozzle attaching-detaching apparatus
1: holder
11: base body
111: space
12: core rod
13: engagement pin
14: clamp
2: robot arm
21: control unit
22: robot arm mount
23: 3D sensor
3: force sensor
4: ladle
41: bottom of ladle
5: floor
6: ladle support
7: sliding nozzle device
71: lower plate
72: lower nozzle
721: nozzle bore
73: plate-receiving metal frame
74: metal sleeve
741: groove
75: holding metal frame
751: catching notch
752: catching through-hole
753: protrusion

1. A lower nozzle attaching-detaching apparatus for attaching and detaching a lower nozzle made of a refractory material with respect to a lower plate made of a refractory material and installed in a sliding nozzle device, the lower nozzle attaching-detaching apparatus comprising:
a holder capable of being attached and detached with respect to a holding metal frame that holds the lower nozzle;
a robot arm having the holder at a tip thereof;
a force sensor to detect a reaction force in a front/rear direction and a reaction force in a rotational direction, the two reaction forces being received by the holder from the holding metal frame along with a movement of the robot arm; and
a control unit to monitor and control the movement of the robot arm, wherein the control unit operates to perform attaching and detaching of the lower nozzle by controlling the movement of the robot arm while monitoring the two reaction forces detected by the force sensor, and two movement amounts in the front/rear direction and in the rotational direction of the robot arm.

2. The lower nozzle attaching-detaching apparatus as claimed in claim 1, wherein when, during the detaching of the lower nozzle, each of the two movement amounts in the rear direction and in the rotational direction of the robot arm reaches a respective predetermined set value without each of the two reaction forces detected by the force sensor reaching a respective predetermined set value, the control unit determines that the detaching of the lower nozzle has been completed normally.

3. The lower nozzle attaching-detaching apparatus as claimed in claim 2, wherein when, during the detaching of the lower nozzle, at least one of the two reaction forces detected by the force sensor reaches the respective predetermined set value, the control unit determines as abnormal detaching, and operates to stop the movement of the robot arm.

4. The lower nozzle attaching-detaching apparatus as claimed in claim 1, wherein when, during the attaching of the lower nozzle, each of the two reaction forces detected by the force sensor reaches a respective predetermined set value, and each of the two movement amounts in the front direction and in the rotational direction of the robot arm reaches a respective predetermined set value, the control unit determines that the attaching of the lower nozzle has been completed normally.

5. The lower nozzle attaching-detaching apparatus as claimed in claim 4, wherein when, during the attaching of the lower nozzle, at least one of the two movement amounts in the front direction and in the rotational direction of the robot arm does not reach the respective predetermined set value at a time when at least one of the two reaction forces detected by the force sensor reaches the respective predetermined set value, the control unit determines as abnormal attaching, and operates to stop the movement of the robot arm.
